(19) United States
(12) Patent Application Publication
(10) Pub. No.: US 2017/0199965 A1
(43) Pub. Date: Jul. 13, 2017

(54) MEDICAL SYSTEM AND METHOD FOR PREDICTING FUTURE OUTCOMES OF PATIENT CARE

(71) Applicant: MedAware Ltd., RaAnana (IL)

(72) Inventor: Edo DEKEL, Tel-Aviv (IL)

(73) Assignee: MedAware Ltd., RaAnana (IL)

(21) Appl. No.: 15/326,485

(22) PCT Filed: Apr. 19, 2016
(86) PCT No.: PCT/IL16/50413

§ 371 Date: Jan. 15, 2017

Related U.S. Application Data
(60) Provisional application No. 62/150,337, filed on Apr. 21, 2015.

(51) Int. Cl. G06F 19/00

(52) U.S. Cl. CPC G06F 19/322; G06F 19/3443

(57) ABSTRACT

A medical data system and method of using same are provided. The medical data system includes a computing platform for using patient-specific data from each of a plurality of patients at various time points to generate a multi-dimensional vector for each of the plurality of patients at each time point of the various time points, thereby providing a plurality of time-related multi-dimensional indices for each patient. The system further uses a multi-dimensional vector generated from data at time T1 of a subject to group the subject with a first cohort of patients and a multi-dimensional vector generated from data at time T2 of the subject to group the subject with a second cohort of patients.

### FIELD AND BACKGROUND OF THE INVENTION

The present invention relates to a medical data system and method of using same for predicting future outcomes of patient care.

In recent years, Electronic Medical Records (EMR) and Computerized Physician Order Entry (CPOE) technologies have been entering the clinical arena. These technologies provide sufficient information to identify potentially harmful prescriptions as well as other present or near term clinical parameters of value, however, since such systems only analyze a specific patient file, they are limited to the information contained therein and thus cannot derive medically-relevant information which can be used to predict long term outcomes of patient care.

Systems for predicting long term outcomes of patient care, including health status, cost of care and the like can significantly improve the effectiveness and efficiency of healthcare systems. One such system is described in US20120041772 which discloses a system for predicting patient prognosis. This system aligns a query patient to a best anchor timestamp of a similar patient and uses the data from the similar patient to predict a long-term outcome measure of the query patient.

While time-related alignment of two patients can be used to predict future outcomes for the less advanced patient (in as far as progression of disease/care) comparing individual patients is challenging due to patient diversity and non-linear progression of diseases.

Thus, there remains a need for a medical data system which can provide a highly accurate prediction of patient care outcomes.

### SUMMARY OF THE INVENTION

According to one aspect of the present invention there is provided a medical data system comprising a computing platform configured for: (a) using patient-specific data from each of a plurality of patients at various time points to generate a multi-dimensional vector for each of the plurality of patients at each time point of the various time points, thereby providing a plurality of time-related multi-dimensional indices for each patient; (b) using the multi-dimensional vector generated from data at time T1 of a subject to group the subject with a first cohort of patients; and (c) using the multi-dimensional vector generated from data at time T2 of the subject to group the subject with a second cohort of patients.

According to further features in preferred embodiments of the invention described below, the computing platform is further configured for: (d) identifying a subset of patients shared by the first and the second cohorts.

According to still further features in the described preferred embodiments the computing platform is further configured for: (e) querying time-related data of the subset of patients to thereby project a data-related value of the subject at a time T3.

According to still further features in the described preferred embodiments the multi-dimensional vector include one or more parameters selected from the groups consisting of demographic parameters, physiological parameters, drug prescription-related parameters, disease related parameters, treatment-related parameters, healthcare provider related parameters and insurer related parameters.

According to still further features in the described preferred embodiments the medical system further comprises using the multi-dimensional vector generated from data at one or more additional times TK . . . N of the subject to group the subject with at least a third cohort of patients.

According to still further features in the described preferred embodiments the computing platform is further configured for: (d) identifying a subset of patients shared by the first, the second and the at least a third cohorts.

According to still further features in the described preferred embodiments data-related value of the subject at a time T3 is a missing value.

According to still further features in the described preferred embodiments data-related value of the subject at a time T3 is selected from the group consisting of a drug prescription, a cost of care, a prognosis, and duration of care.

According to another aspect of the present invention there is provided a method of associating a subject with a patient cohort comprising: (a) using patient-specific data from each of a plurality of patients at various time points to computationally generate a multi-dimensional vector for each of the plurality of patients at each time point of the various time points, thereby providing a plurality of time-related multi-dimensional indices for each patient; (b) using the multi-dimensional vector generated from data at time T1 of the subject to computationally group the subject with a first cohort of patients; (c) using the multi-dimensional vector generated from data at time TN of the subject to computationally group the subject with at least a second cohort of patients; (d) identifying a subset of patients shared by the first and the at least a second cohorts thereby associating the subject with the patient cohort.

According to still further features in the described preferred embodiments the method further comprises: (e) querying time-related data of the subset of patients to thereby project a data-related value of the subject at a time T3.

According to still further features in the described preferred embodiments the multi-dimensional vector include one or more parameters selected from the groups consisting of demographic parameters, physiological parameters, drug prescription-related parameters, disease related parameters, treatment-related parameters, healthcare provider related parameters and insurer related parameters.

According to still further features in the described preferred embodiments the method further comprises using the multi-dimensional vector generated from data at one or more times TK . . . N of the subject to group the subject with at least a third cohort of patients.

According to still further features in the described preferred embodiments the method further comprises: (f) identifying a subset of patients shared by the first, the second and the at least a third cohorts.

According to still further features in the described preferred embodiments data-related value of the subject at a time T3 is a missing value.

According to still further features in the described preferred embodiments data-related value of the subject at a time T3 is selected from the group consisting of a drug prescription, a cost of care, a prognosis and a duration of care.

The present invention successfully addresses the shortcomings of the presently known configurations by providing a system for accurately predicting health care outcomes of a subject.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE SEVERAL VIEWS OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1a-b is a block diagram illustrating the present medical data system (FIG. 1a) and stored modules (FIG. 1b).

FIG. 2 is a flowchart illustrating identification of a reference cohort according to the teachings of the present invention.

FIG. 3 illustrates predicted future costs of care and treatment outcomes for a subject analyzed using the teachings of the present invention.

FIG. 4 illustrates use of the present invention to provide a group similarity measure.

### DESCRIPTION OF THE PREFERRED EMBODIMENTS

The present invention is of a system for predicting future outcomes of patient care. Specifically, the present invention can be used to predict, for example, prognosis, cost of care and treatment needs of a subject at any stage of treatment or a disease progression.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

While systems for predicting prognosis of a patient are known, such systems typically utilize historical data of one or more patients as a future predictor for the health status of another medically similar patient.

Similarity between two individuals or an individual and a cohort can change over time. While a patient “A” at time X can be most similar to patient “B” at time Y, the same patient A at time X+1 might not be similar to patient B at time Y+1, or time Y+2. As such, clustering a patient A with a patient B or with a cohort C based on a best fit time point might not be sufficient to derive accurate predictors of future care.

While reducing the present invention to practice, the present inventors have devised a system which utilizes a more complex multi-dimensional, time-dependent similarity approach to identify a patient cohort that is medically similar to a subject at several time points of the subject, thereby considerably increasing the likelihood of identifying accurate predictors (a future data-related value) of outcomes of care for the subject.

Thus, according to one aspect of the present invention there is provided a medical data system for predicting future outcomes of subject care, including for example, future prognosis, future health status, future costs of care, future morbidities or co-morbidities, life span, drug needs, risk management, quality management and population management.

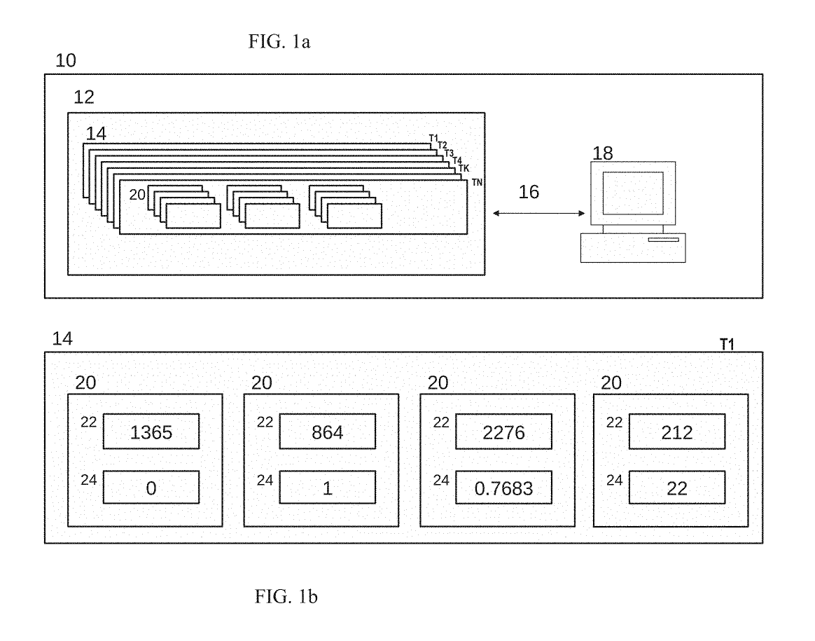

FIGS. 1a-b illustrate the medical database system of the present invention which is referred to herein as system 10.

System 10 stores data related to a plurality of subjects (refers to the queried individual) and patients (refers to the cohort and reference cohort individuals); for the sake of clarity, only data related to a single subject is illustrated in FIG. 1a.

System 10 includes a data unit 12 for storing modules 14 representing medical records of a subject at different time points (T₁, T₂, T₃, T₄, . . . T_{K}, T_{N}). Modules 14 are typically represented as multi-dimensional vectors, each tagged with a different time stamp; FIG. 1b illustrates module 14 at time T₁. The multi-dimensional vector for each subject at each time point of the various time points provides a plurality of time-related multi-dimensional indices. A similar multi-dimensional vector is generated for each patient at each time point.

Modules 14 are stored as records in a database such as a standard relational database, as rows in a delimiter-separated text file, or in any such other data storage format. Data unit 12 is stored on a user accessible storage medium (magnetic/optical drive) of a computer platform such as a desktop, laptop, work station, server and the like. The computing platform can be accessed locally or through a communication network 16 through any computing devices 18 including stationary (e.g. desktop computers) and mobile (e.g. smartphones, tablets etc) devices.

Each module 14 of the subject includes information on medically-relevant parameters collected at a specific time point of care, i.e. the medically-relevant parameters of the subject which populate a single module 14 were all collected (or entered into the subject's file) at a single time point. Thus, a first module 14 can include medically-relevant parameters ‘collected’ at T₁, a second module 14 can include medically-relevant parameters at T₂, a third module 14 can include medically-relevant parameters at T₃ and so on. Each subject can be represented by any number of modules 14 depending on the duration of care, type of disease and the like. Time spacing between various time periods need not be equal and can be hours, days, weeks or months. The number of modules per subject is unlimited and is determined by the subject's medical history. For example, the modules can be created with reference to times of actual medical events or times related to medical events, e.g. “1 year prior to diagnosis with diabetes type II” or “1 month following hospitalization”. The modules can also be created with reference to the subject's age, i.e. “diagnosis when the subject was 20 years old”. In any case. timeframes can be determined by medical events or a preset time period. As is shown in FIG. 1b, each medically-relevant parameter of module 14 is represented by a module element 20. Each element 20 is assigned a specific identifier 22 in the module and a numerical value 24 corresponding to the medically-relevant parameter. The numerical value can be a Boolean, discrete or continuous numerical value.

Examples of medically relevant parameters includes, but are not limited to, hospitalization, point of care type and name, drugs prescribed, physiological parameters such as age, weight, height, clinical parameters such as diagnosed disorders, blood test results, chemistry, blood pressure, heart rate, a treatment related parameter such as surgery, socioeconomic status, adherence to therapy, physical activity and genetic factors.

Each parameter occupies a specific element of the module and is identified by a specific location (numerical) or tag (code). In addition, as is mentioned above, each parameter is assigned a value which can be Boolean (e.g. true or false with respect to diagnosis, drug prescribed, past visit in a particular specialty clinic), discrete (e.g. number of times a particular drug has been prescribed in the past, age in months) or continuous (e.g. a clinical parameter such as blood count). The discrete or continuous value assigned to each element can be normalized to lie within a predefined range or have certain desirable statistical properties.

Each module of the subject is constructed from a snapshot of a subject's health record at a specific point in time, i.e. the data in the patient medical file at time T, day X, month Y and year Z. The health record data is processed and a formal representation of the data as a numerical vector of fixed length−R=(f1,f2,f3, . . . ,fN) is generated.

Each element of this vector is a “feature” of the patient's representation at the specific point in time.

The vector generation process has 3 main stages: data extraction, data encoding, and feature calculation:
a. In the data extraction stage, textual data entered at, or stamped with a specific time in the medical record is represented using predefined codes. For example, a diagnosis of “Subtrochanteric fracture of femur” can be transformed to its ICD10 code S72.2. Natural Language Processing (NLP) techniques can be used to identify words and phrases within free text stored in the EMR, from which diagnoses and other informative data elements can be thus extracted.
b. In the data encoding stage, the extracted data is transformed into purely numerical form. For example, in the previous example, the ICD10 code S72.2 can be transformed to an index 38172 using an enumeration table of all ICD10 codes.
c. In the feature calculation stage, predefined elements of the representation are calculated based on the numerical representation of the data extracted from the patient record. The final representation of the patient record is an ordered set of all the features calculated at this stage.

The system of the present invention can further include an inference engine for comparing, based on the identifiers, several modules of a specific subject, each at a specific time point (T₁, T₂, T₃, T₄, . . . T_{K}, T_{N}), to a plurality of modules of patients (at different time points) in order to identify a specific cohort of patients that is similar to each time-stamped module of the subject. Such comparison can take into account the values of each module element of the modules (patient and subject) or values of at least a portion of these elements. In any case, once such module-specific cohorts are identified, they are further analyzed to identify a subset of patients that is present in all cohorts.

This subset of patients (also referred to herein as a “reference cohort”) can then be used to predict future outcomes of care for the subject (predict a future data-related value).

Patients “closer in time” to the subject are more likely to be members of the cohort. For example, if the subject was hospitalized 1 year after being diagnosed with diabetes type II, then another patient who was hospitalized 1 year after being diagnosed with diabetes type II is more likely to be part of the cohort than a patient who was hospitalized 2 years after being diagnosed with diabetes type II. Moreover, the resolution of the temporal proximity is proportional to the time separation from the key event. For example, if the time stamp is a month prior to a key event (i.e. hospitalization, death etc.), then temporal changes of days/weeks are referenced, however, if the time stamp is 10 years prior to the key event, temporal changes over years are then referenced.

It will be appreciated that the reference cohort identified by the present system considerably increases the accuracy of a predictor since such a reference cohort includes patients that are similar to the subject over several time points during the subject's care history.

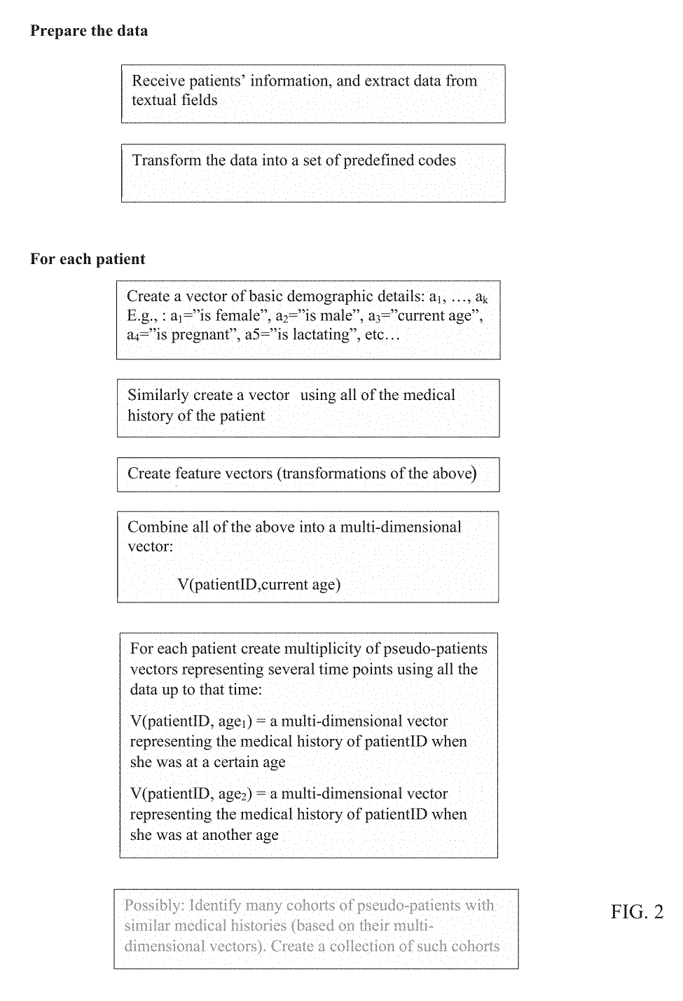

FIG. 2 is a flow chart diagram summarizing the process of identifying the reference cohort of the present invention.

Several approaches for comparing module data of the subject and patients and for clustering the subject with a cohort of patients based on data similarities are described in WO2014111933 which is incorporated herein by reference. Alternative approaches can utilize known clustering tools such as k-nearest neighbors, principal component analysis, decision trees and similar algorithms.

Clustering can be effected based on the predictors relevant to the subject. For example, if the predictor sought is cost of care, then the reference cohort will be identified via some or all of the medically related parameters described above but also based on point of care and/or insurance provider. The point of care parameter can be a specific hospital, or a hospital of similar size at a similar location (e.g. same city in the United States). Patients “closer in regards to point of care parameter” to the subject are more likely to be members of the clustered cohort. Similarly, if the parameter for comparison is socio-economic, then patients closer socio-economically to the subject are more likely to be members of the clustered cohort.

The system of the present invention can integrate with an EMR system to electronically obtain historical patient records as well as any new information related to the patient. The System can be used in a hospital setting, in a community setting, in a pharmacy setting, in an insurance company setting, in a pharmacy or pharmacy benefits manager (PBM) setting, or in a combination of the above.

The database component of the present system can store the modules as blobs (binary large objects). The patient object database contains serialized representations of patient ‘objects’. When the data pertaining to a specific patient needs to be online, the corresponding serialized object will be loaded into memory, and will be available for update and analysis. In a hospital setting, the object will be loaded when the patient registers at the ER, is admitted or arrives at the outpatient clinic. In a community setting, the object will be loaded when the patient is scheduled to visit the family physician, nurse or consultant. When new data regarding the patient is received (i.e. new blood tests) the patient object will be loaded, updated, prescription errors will be generated (if needed) and the object will be subsequently serialized and saved back in the database.

As is mentioned hereinabove, the present system can be used to predict near or long term outcomes of care for any subject. The present system can provide feedback on queries such as:

1. which drug(s) prescribed to at least some of the patients of the reference cohort (e.g. to 50% or more of the patients) is not prescribed to the subject;

2. which drug(s) prescribed to the subject is not prescribed to at least some of the patients of the reference cohort (e.g. to 50% or more of the patients);

3. how does the healthcare cost of the subject in the last X years compare to the reference cohort;

4. what is the predicted healthcare cost of the subject in the next X years;

5. what is the predicted outcome of this patient in the next X years;

6. what is the risk for death, disability, hospital admission, readmission for the subject.

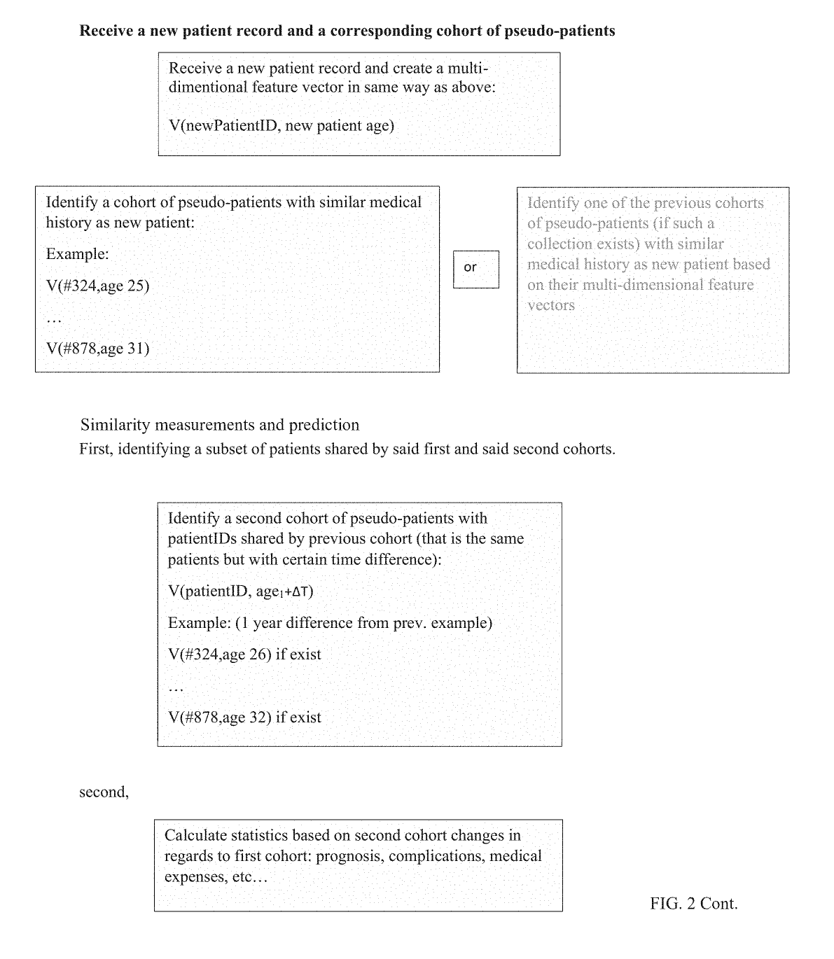

FIG. 3 illustrates prediction of future costs of care and treatment outcomes for patient 56 (the subject) based on three patients of the reference cohort. Patients' diagnoses, blood test, and prescriptions are marked by Dx, BT and Rx respectively. Patients 51, 58 and 60 form a cohort of patients with medical history similar to the subject, up to a similarity threshold. Based on the known future medical history of the 3 patients in the cohort, a parameter (such as future treatment) can be estimated for the subject. The similarity threshold set for this comparison is 70%, however, any threshold can be set by the present system. With lower threshold more patients would fit the cohort and thus the statistics would be based on larger amount of patients at the expense of lower similarity of said patients in said cohort. Some embodiments would apply a weighting scheme in the averaging of the predicted parameters based on the similarity measure of patients in the cohort.

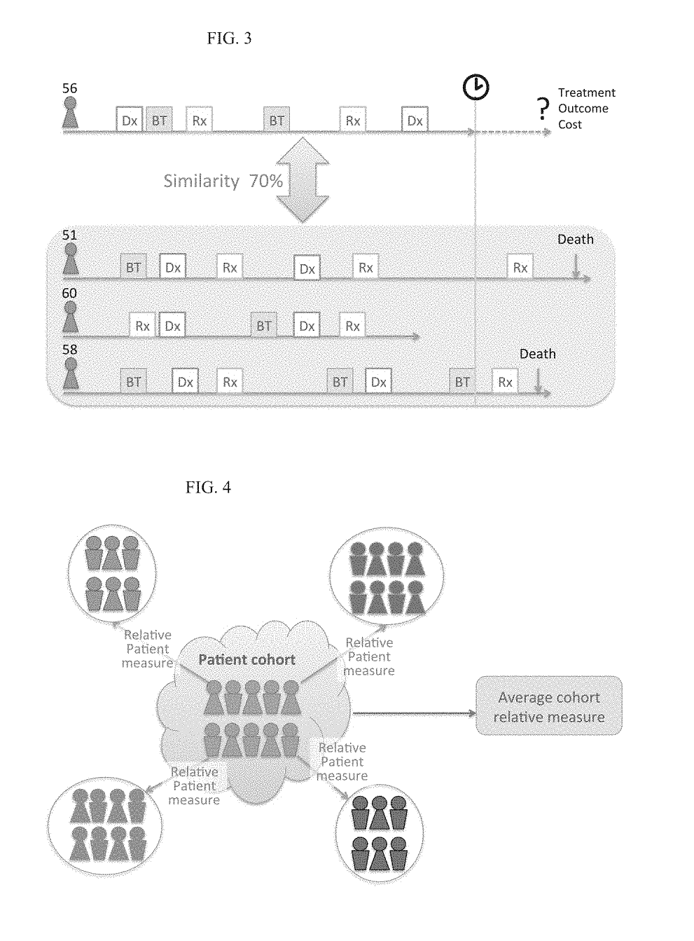

FIG. 4 illustrates application of the present invention to provide a similarity measure for groups (rather than an individual). When measuring a quality measure of a group, the group measure is the average of the relative measurements of each individual compared to his own reference cohort. Group similarity measures enables correction for differences between individuals of a population and provides a tool for comparing groups rather than an individual to a group. For example, when comparing quality of care in two units in the same hospital (say general vs. coronary care units). In such cases the estimated quality of care of each patient in each unit (estimated by comparing to a cohort of similar patients) can be averaged to get a quality of care score for the whole unit. The unit score of the two units can then be compared to qualify the unit.

The data-related values predicted by the present system can also be used to qualify care at a specific facility or under a specific doctor. For example, comparing actual cost of care of certain hospital ward with average cost of care of comparable cohorts of patients (see Examples section below).

The data-related values predicted by the present system can also be used to determine the effectiveness of long term treatment of a specific subject by comparison to the chronic medication prescribed to a reference cohort or to provide a quality measure for hospital departments, by calculating the average of a quality measure difference between each subject in each hospital department and a respective reference cohort.

Additional objects, advantages, and novel features of the present invention will become apparent to one ordinarily skilled in the art upon examination of the following examples, which are not intended to be limiting.

### EXAMPLES

Reference is now made to the following example, which together with the above descriptions, illustrate the invention in a non limiting fashion.

### Estimating a Future Number of Hospitalizations

A 55 year old female subject diagnosed with diabetes type II at age 50 with several complications over time was used to identify a reference cohort in order to estimate the expected number of hospitalizations (or cost of care) up to age 60.

The subject data was arranged in time-stamped modules as described above. 31 modules were constructed at the following time point: ages 51, 52, 53, 54 and 55 (5 age modules), 15 visits to a physician (15 diagnoses modules), 8 measurements of blood glucose over the period (8 blood test modules) and 3 hospital visits (3 outpatient modules). The modules were compared to other patients' modules, spread over a 4-6 year period (allowing for uneven progress of disease) from first diagnosis at an age approximately 50. A reference cohort was extracted as described above. The reference cohort exhibited similar disease progression (as indicated by blood tests and diagnoses of complications) up to age 55; data was available for this reference cohort to at least age 60. The average number of hospitalizations (and related cost of care) for these 30 patients over 5 years (age 55 to 60) and their extended medical history was calculated, and was used to derive an average projected number of hospitalizations (and cost of care) for the subject for the next 5 years.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A medical data system comprising a computing platform configured for:
(a) using patient-specific data from each of a plurality of patients at various time points to generate a multi-dimensional vector for each of said plurality of patients at each time point of said various time points, thereby providing a plurality of time-related multi-dimensional indices for each patient;
(b) using said multi-dimensional vector generated from data at time T1 of a subject to group said subject with a first cohort of patients; and
(c) using said multi-dimensional vector generated from data at time T2 of said subject to group said subject with a second cohort of patients.

2. The medical data system of claim 1, wherein said computing platform is further configured for:
(d) identifying a subset of patients shared by said first and said second cohorts.

3. The medical data system of claim 1, wherein said computing platform is further configured for:
(e) querying time-related data of said subset of patients to thereby project a data-related value of said subject at a time T3.

4. The medical data system of claim 1, wherein said multi-dimensional vector include one or more parameters selected from the groups consisting of demographic parameters, physiological parameters, drug prescription-related parameters, disease related parameters, treatment-related parameters, healthcare provider related parameters and insurer related parameters.

5. The medical system of claim 1, further comprising using said multi-dimensional vector generated from data at one or more additional times TK . . . N of said subject to group said subject with at least a third cohort of patients.

6. The medical data system of claim 5, wherein said computing platform is further configured for:
(f) identifying a subset of patients shared by said first, said second and said at least a third cohorts.

7. The medical system of claim 3, wherein data-related value of said subject at a time T3 is a missing value.

8. The medical system of claim 3, wherein data-related value of said subject at a time T3 is selected from the group consisting of a drug prescription, a cost of care, a prognosis, and duration of care.

9. A method of associating a subject with a patient cohort comprising:
(a) using patient-specific data from each of a plurality of patients at various time points to computationally generate a multi-dimensional vector for each of said plurality of patients at each time point of said various time points, thereby providing a plurality of time-related multi-dimensional indices for each patient;
(b) using said multi-dimensional vector generated from data at time T1 of the subject to computationally group the subject with a first cohort of patients;
(c) using said multi-dimensional vector generated from data at time TN of the subject to computationally group the subject with at least a second cohort of patients;
(d) identifying a subset of patients shared by said first and said at least a second cohorts thereby associating the subject with the patient cohort.

10. The method of claim 9, further comprising:
(e) querying time-related data of said subset of patients to thereby project a data-related value of said subject at a time T3.

11. The method of claim 9, wherein said multi-dimensional vector include one or more parameters selected from the groups consisting of demographic parameters, physiological parameters, drug prescription-related parameters, disease related parameters, treatment-related parameters, healthcare provider related parameters and insurer related parameters.

12. The method of claim 9, further comprising using said multi-dimensional vector generated from data at one or more times TK . . . N of said subject to group said subject with at least a third cohort of patients.

13. The method of claim 12, further comprising:
(f) identifying a subset of patients shared by said first, said second and said at least a third cohorts.

14. The method of claim 10, wherein data-related value of said subject at a time T3 is a missing value.

15. The method of claim 10, wherein data-related value of said subject at a time T3 is selected from the group consisting of a drug prescription, a cost of care, a prognosis, a risk, a quality of care, a duration of care, a health status, a morbidity or co-morbidity and a life span.
